(19) United States
(12) Patent Application Publication
(10) Pub. No.: US 2006/0074993 A1
(43) Pub. Date: Apr. 6, 2006

(54) System and method for management of recovery time objectives of business continuity/disaster recovery IT solutions

(76) Inventors: Chandrasekhar Pulamarasetti, Bangalore (IN); Rajasekhar Mulpuri, Bangalore (IN); Lakshman Narayanaswamy, Bangalore (IN); Ravi Kumar Raghunathan, Bangalore (IN); Krishna Nimishakavi, Bangalore (IN); Rajasekhar Vonna, Bangalore (IN)

Correspondence Address: LAWRENCE Y.D. HO & ASSOCIATES PTE LTD, 30 BIDEFORD ROAD, #07-01, THONGSIA BUILDING, SINGAPORE, 229922, SG

(21) Appl. No.: 11/240,764

(22) Filed: Oct. 3, 2005

Related U.S. Application Data
(60) Provisional application No. 60/615,640, filed on Oct. 4, 2004.

(51) Int. Cl. G06F 17/30

(52) U.S. Cl. 707/200

(57) ABSTRACT

The present invention provides a system and method for management of Recovery Time Objective (RTO) of a business continuity or disaster recovery solution. The system comprises a management server logically coupled with at least a first computer, at least a second computer, and a network coupling the first and the second computers. The first and second computers host at least one continuously available application, at least one data protection scheme for replicating the application data and at least one operating system; the application data being periodically replicated from the first computer to at least the second computer. The system manages RTO by inputting an RTO value for the solution, calculating a real time RTO value for the solution, and making the real time RTO value less than or equal to the input RTO value.

### FIELD OF INVENTION

The present invention relates generally to computer systems. More particularly, the present invention relates to monitoring, measurement and management of Recovery Time Objectives (RTO) of enterprise IT business continuity or disaster recovery solutions.

### BACKGROUND OF THE INVENTION

In the increasingly competitive times of today, implementing systems and methods for maintaining business continuity is no longer an optional requirement for business enterprises, especially for enterprises that use or are fully or partially dependent on Information Technology (IT). Such enterprises can be broadly termed as IT enterprises. Since the efficient working of most of such IT enterprises depends on their business continuity or disaster recovery management infrastructure, implementing a sound enterprise IT business continuity or disaster recovery solution has almost become a mandatory requirement. Costs incurred during business downtime are usually significant, thereby dictating a need for implementing a business continuity solution. The design and choice of the business continuity or disaster recovery solution is primarily driven by a Recovery Time Objective (RTO) that is acceptable to the IT enterprise.

RTO for an IT enterprise business continuity or disaster recovery solution is a time measure that indicates how soon data and related application must be available to the enterprise after an outage has happened. For example, an enterprise may determine, based on impact to business analysis, that it cannot have the production computer down for more then two hours. Therefore, the RTO for the enterprise would be two hours and in case the production computer fails, it must be made available again within two hours.

Enterprise data may be generally classified into four categories. (1) Critical “Tier One” data, where loss of data has an immediate impact on the enterprise's revenue or functioning; (2) Vital “Tier Two” data, where loss of data has a significant impact on the enterprise's revenue or functioning; (3) Essential “Tier Three” data, where loss of data has some impact on the enterprise's revenue or functioning; and (4) Non-Essential “Tier Four” data, where loss of data has minimal impact on the enterprise's revenue or functioning. Therefore, the challenge faced by most enterprises lies in identifying the criticality of their IT enterprise application data and impact of loss of the same. One way to achieve this goal is to recognize an acceptable amount of time the application may remain unavailable. Hence, an RTO measure is used to characterize the maximum amount of time the enterprise IT application may be unavailable.

A conventional business continuity or disaster recovery solution has three main components namely: an enterprise application that requires being available continuously, a data protection scheme that makes a copy of the application data, and the entire supporting infrastructure which comprises computer servers, storage arrays and local and remote networks. Conventional business continuity or disaster recovery solutions based on an RTO measure may not integrate with all the three components. Some of the currently available business continuity or disaster recovery solutions work with a static value of RTO and do not provide for a real time measurement of RTO based on real time inputs obtained from all the three components. Hence, there is need for a business continuity or disaster recovery solution that is based on real time measurement and management of RTO by using real time inputs from the mentioned components.

Some of the available methods to manage RTO in a business continuity or disaster recovery solution are manual, and usually entail an operator monitoring the proper functioning of each of the three components and taking appropriate corrective actions, if required. The constant manual monitoring and performing of corrective actions maintains business continuity of the enterprise application that requires being available continuously. Such corrective actions have to be customized for every type of enterprise application, data protection scheme and supporting infrastructure components used for the business continuity or disaster recovery solution. Therefore, these actions require that the operator possesses an in-depth technical knowledge of all the components in the business continuity or disaster recovery solution. Such dependence on manual intervention may lead to erroneous operation of the solution and added costs for the business enterprise that implements the solution.

Therefore, there is need for an automated business continuity or disaster recovery solution in which RTO is continuously managed to a user desired or configured value.

### SUMMARY OF THE INVENTION

The present invention provides automated systems and methods for monitoring, measurement and management of Recovery Time Objectives (RTO) of enterprise IT business continuity or disaster recovery solutions.

It is an objective of the present invention to provide systems and methods that monitor the RTO of enterprise IT business continuity or disaster recovery solutions, in real time.

It is another objective of the present invention to provide systems and methods that manage the enterprise IT business continuity or disaster recovery solutions such that the desired RTO value is achieved.

It is yet another objective of the present invention to provide systems and methods for monitoring and managing the RTO of enterprise IT business continuity or disaster recovery solutions that integrate with the various components of the business continuity or disaster recovery solution.

It is still another objective of the present invention to provide systems and methods for managing the RTO of enterprise IT business continuity or disaster recovery solutions that enable a user to input or configure a desired RTO value for the business continuity or disaster recovery solution.

It is still another objective of the present invention to provide systems and methods for managing the RTO of enterprise IT business continuity or disaster recovery solutions that raise alerts and alarms when the RTO deviates from its desired or configured value.

It is yet another objective of the present invention to provide systems and methods for managing the RTO of enterprise IT business continuity or disaster recovery solutions that take corrective actions to maintain the RTO at its desired or configured value.

It is still another objective of the present invention to provide systems and methods for managing the RTO of enterprise IT business continuity or disaster recovery solutions that specify policies which further decide actions to be performed when the RTO value deviates from its desired or configured value.

It is another objective of the present invention to provide systems and methods for managing the RTO of enterprise IT business continuity or disaster recovery solutions that may be executed on heterogeneous computer servers, operating systems, hardware and software environments.

It is yet another objective of the present invention to provide systems and methods for managing the RTO of enterprise IT business continuity or disaster recovery solutions that interface with various data protection techniques used by the business continuity or disaster recovery solution.

It is still another objective of the present invention to provide systems and methods for managing the RTO of enterprise IT business continuity or disaster recovery solutions that may be implemented in software or a combination of software and hardware.

It is another objective of the present invention to provide systems and methods for managing the RTO of enterprise IT business continuity or disaster recovery solutions that may be implemented in distributed or centralized environments.

To meet the above mentioned and other objectives, the present invention provides a system for management of Recovery Time Objective (RTO) of a business continuity or disaster recovery solution. The system comprises a management server logically coupled with at least a first computer, at least a second computer, and a network coupling the first and the second computers. The first and second computers host at least one continuously available application, at least one data protection scheme for replicating the application data and at least one operating system; the application data being periodically replicated from the first computer to at least the second computer. The system managing RTO by inputting an RTO value for the solution, calculating a real time RTO value for the solution, and making the real time RTO value less than or equal to the input RTO value.

In an embodiment of the present invention, the first and the second computers are coupled to one or more storage units. A plurality of agents of the management server are deployed on at least the first computer, at least the second computer, the network coupling the first and the second computers, and the one or more storage units. The management server periodically polls at least one of its agents integrated with at least, the application, the data protection scheme and the operating system running on the first computer, the application, the data protection scheme and the operating system running on the second computer, and the network, for calculating the real time RTO value. In an embodiment of the present invention, the management server periodically polls at least one of its agents integrated with at least one storage unit, for calculating the real time RTO value. The data protection scheme comprises data replication techniques based on one or more of tape backup, disk backup, block level replication, file level replication, point in time replication and archive logs. The system of the present invention is configurable on heterogeneous platforms comprising heterogeneous servers and operating systems.

The present invention also provides a method for management of Recovery Time Objective (RTO) of a business continuity or disaster recovery solution. The method comprises the steps of inputting an RTO value for the solution, calculating a real time RTO value for the solution, and managing the real time RTO value to make it less than or equal to the input RTO value. The method further comprises the step of continuously repeating the steps of calculating a real time RTO value for the solution and managing the real time RTO value to make it less than or equal to the input or configured RTO value.

In an embodiment of the present invention, the step of inputting an RTO value for the solution comprises the steps of prompting a user to input a desired RTO value for the solution, computing time and periodic setting values for the solution, based on the desired RTO value, and configuring the solution, based on the computed time and periodic setting values.

In an embodiment of the present invention, the step of calculating a real time RTO value for the solution comprises the steps of obtaining current state of an application of the solution, obtaining current state of a data protection scheme replicating the application data, obtaining current state of a network supporting the solution, obtaining current state of an operating system supporting the solution and calculating a real time RTO value using at least one of the current obtained values of each of the state of the application, the data protection scheme, the network and the operating system.

In an embodiment of the present invention, the step of managing the real time RTO value to make it less than or equal to the input RTO value comprises the steps of raising an alarm if the computed RTO value is greater than the input RTO value, and performing at least one corrective action based on at least one predefined corrective policy. In another embodiment of the present invention, the step of managing the real time RTO value to make it less than or equal to the input RTO value comprises the steps of raising an alarm if the computed RTO value is greater than the input RTO value, prompting the user to define at least one corrective policy, and performing at least one corrective action based on the user defined corrective policy.

In an embodiment of the present invention, the step of managing the real time RTO value to make it less than or equal to the input or configured RTO value comprises the step of repeating the steps of calculating a real time RTO value for the solution if the computed RTO value is less than or equal to the input RTO value.

In an embodiment of the present invention, the step of computing time and periodic setting values for the solution based on the desired RTO value, comprises one or more of the steps of computing a periodic interval for performing an operation to ensure data consistency of replicated data on the second computer, computing a periodic interval for performing an operation to apply replicated data to the application running on the second computer, computing readiness level of the second computer, computing readiness level of the one or more storage unit; and computing readiness level of the network.

The method for management of Recovery Time Objective (RTO) of a business continuity or disaster recovery solution described in the present invention is operable on heterogeneous platforms comprising heterogeneous servers and operating systems.

The present invention also provides a computer program product comprising a computer usable medium having a computer readable program code embodied therein for management of Recovery Time Objective (RTO) of a business continuity or disaster recovery solution. The computer program product comprises program instruction means for inputting an RTO value for the solution, program instruction means for calculating a real time RTO value for the solution, and program instruction means for managing the real time RTO value to make it less than or equal to the input RTO value. In an embodiment of the present invention, the computer program product further comprises program instruction means for continuously repeating the steps of calculating a real time RTO value for the solution and managing the real time RTO value to make it less than or equal to the input RTO value.

In an embodiment of the present invention, the program instruction means for inputting an RTO value for the solution comprise program instruction means for prompting a user to input a desired RTO value for the solution, program instruction means for computing time and periodic setting values for the solution, based on the desired RTO value, and program instruction means for configuring the solution, based on the computed time and periodic setting values.

In an embodiment of the present invention, the program instruction means for calculating a real time RTO value for the solution comprise program instruction means for obtaining current state of an application of the solution, program instruction means for obtaining current state of a data protection scheme replicating the application data, program instruction means for obtaining current state of a network supporting the solution, program instruction means for obtaining current state of an operating system supporting the solution, and program instruction means for calculating a real time RTO value using at least one of the current obtained values of each of the state of the application, the data protection scheme, the network and the operating system.

In an embodiment of the present invention, the program instruction means for managing the real time RTO value to make it less than or equal to the input RTO value comprise program instruction means for raising an alarm if the computed RTO value is greater than the input RTO value, and program instruction means for performing at least one corrective action based on at least one predefined corrective policy. In another embodiment of the present invention, the program instruction means for managing the real time RTO value to make it less than or equal to the input RTO value comprise program instruction means for raising an alarm if the computed RTO value is greater than the input RTO value, program instruction means for prompting the user to define at least one corrective policy, and program instruction means for performing at least one corrective action based on the user defined corrective policy.

In an embodiment of the present invention, the program instruction means for managing the real time RTO value to make it less than or equal to the input RTO value comprise program instruction means for repeating the steps of calculating a real time RTO value for the solution, if the computed RTO value is less than or equal to the input RTO value.

In an embodiment of the present invention, the program instruction means for computing time and periodic setting values for the solution based on the desired RTO value, comprise one or more of program instruction means for computing a periodic interval for performing an operation to ensure data consistency of replicated data on the second computer 106, program instruction means for computing a periodic interval for performing an operation to apply replicated data to the application running on the second computer 106, program instruction means for computing readiness level of the one or more storage unit; and program instruction means for computing readiness level of the network.

The computer program product for management of Recovery Time Objective (RTO) of a business continuity or disaster recovery solution described in the present invention is operable on heterogeneous platforms comprising heterogeneous servers and operating systems.

### BRIEF DESCRIPTION OF THE ACCOMPANYING DRAWINGS

The present invention is described by way of embodiments illustrated in the accompanying drawings wherein:

FIG. 1 illustrates an exemplary environment in which the system for management of recovery time objectives (RTO) for maintaining business continuity of an Information Technology (IT) solution operates;

FIG. 2A and FIG. 2B depict a flowchart illustrating the steps involved in monitoring, measurement and management of Recovery Time Objectives (RTO) of an enterprise IT business continuity or disaster recovery solution, in accordance with an embodiment of the present invention;

FIG. 3 is a screenshot of an exemplary GUI for prompting a user to input a desired RTO value, in accordance with an embodiment of the present invention; and

FIG. 4 is a screenshot of an exemplary GUI conveying the difference between the computed and user input RTO values, in accordance with an embodiment of the present invention.

### DETAILED DESCRIPTION OF THE INVENTION

The present invention would now be discussed in context of embodiments as illustrated in the accompanying drawings.

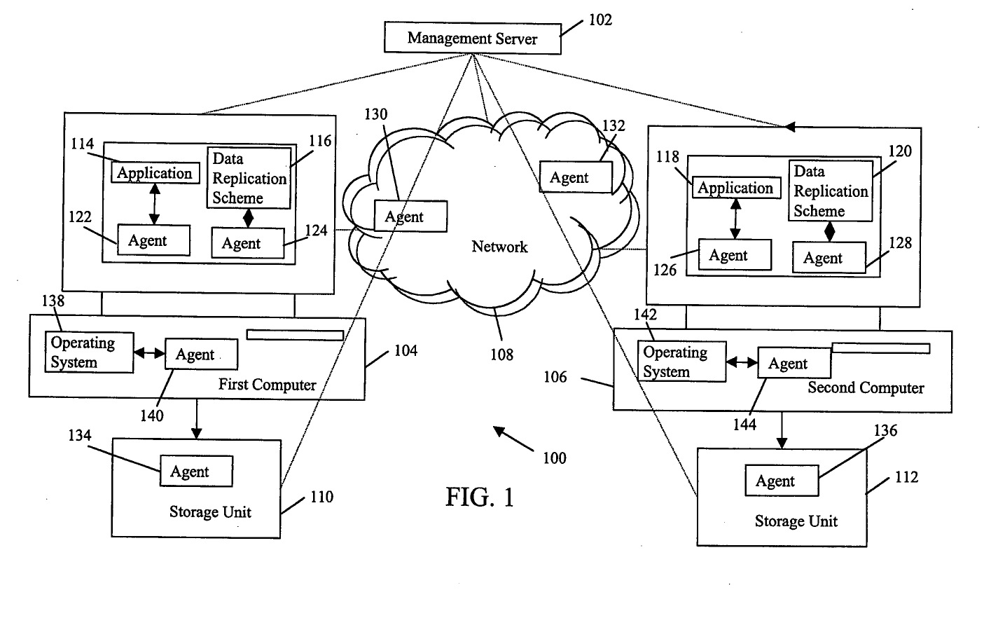

FIG. 1 illustrates an exemplary environment in which the system for management of recovery time objective (RTO) for maintaining business continuity of an Information Technology (IT) enterprise operates, in accordance with an embodiment of the present invention. System 100 comprises a management server 102, a first computer 104, a second computer 106, a network 108 connecting the first computer 104 and the second computer 106, a first storage unit 110 connected to the first computer 104, and a second storage unit 112 connected to the second computer 106. An application 114 of the IT enterprise that is required to be available continuously runs on the first computer 104. A data protection scheme 116 is configured to protect the application 114. An instance 118 of the application 114 runs on the second computer 106. An instance 120 of the data protection scheme 116 is configured to protect the application 118. In an embodiment of the present invention, both the first and the second computers are connected to a single storage unit. In different embodiments of the present invention, there may be more than one first and/or second computers and/or storage units. The second computer 106 is maintained in a standby mode. In various embodiments of the present invention the second computer 106 may be maintained in a hot, cold or warm standby mode. Operating system 138 running on the first computer 104 and operating system 142 running on the second computer 106 supports the operation of an enterprise IT business continuity or disaster recovery solution.

In accordance with an embodiment of the present invention, the first computer 104 and the second computer 106 are at geographically separate locations. The management server 102 is logically connected to the first computer 104, the second computer 106, the network 108, the first storage unit 110 and the second storage unit 112. In an embodiment of the present invention the logical connection maybe an IP network connection.

In various embodiments of the present invention, the first storage unit 110 and the second storage unit 112 are connected to the first computer 104 and the second computer 106 respectively either as direct attached SCSI connection or using IP or Fibre Channel connectivity or any other connection method. Also, in various embodiments of the present invention, the network 108 may be a Local area network (LAN) or a Wide area network (WAN).

A plurality of agents of the management server 102 are deployed on the first computer 104, the second computer 106, the network 108, the first storage unit 110 and the second storage unit 112. Agents 122 and 126 are integrated with the applications 114 and 118 respectively. The Agents 122 and 126 continuously monitor and maintain the state of the applications 114 and 118 and provide a real time status to the management server 102.

Agents 124 and 128 are integrated with the data protection schemes 116 and 120 respectively and continuously monitor and maintain the state of the data protection schemes. In an embodiment, the agents 124 and 128 monitor and maintain replication logs and queue sizes of the data protection scheme. In various embodiments of the present invention, varied data protection schemes may be used. In an embodiment, a traditional tape backup scheme is used wherein the application 114 data on the first computer 104 is replicated (backed up) onto tape media. This replicated application data is then transported from the tape media to the second computer 106. Then the application data on the tape media is restored onto the application 118 running on the second computer 106 resulting in the recovery of the application 114.

In another embodiment of the present invention, block level replication using storage array is used as the data protection scheme, wherein the storage volumes, on which archive logs are stored on the first computer 104 are replicated to the second computer 106. These volumes are then restored onto the second computer 106, and applied to the application 118, resulting in the recovery of the application 114. In other embodiments, various other data protection schemes such as file based replication techniques that replicate archive log files may be used. The system 100 for management of RTO for maintaining business continuity of an Information Technology (IT) enterprise as described in the present invention, fully supports configuration of any type of data protection scheme being used. The system 100 also supports the monitoring and administration of the data protection scheme being used.

Agents 130 and 132 of the management server 102 are integrated with the network 108, agent 134 is coupled with the first storage unit 110 and agent 136 is coupled with the second storage unit 112, as illustrated in FIG. 1. Agents 140 and 144 are integrated with operating system 138 and 142 respectively and monitor and maintain the state of the operating systems. The management server 102 periodically communicates with its agents using both synchronous and asynchronous communication techniques to monitor and maintain the state of the various components of the system 100.

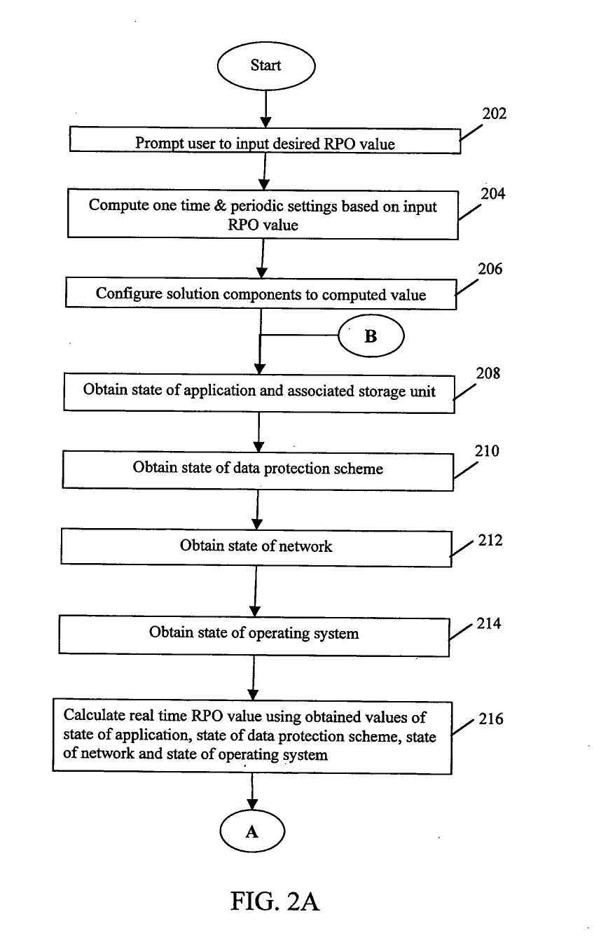

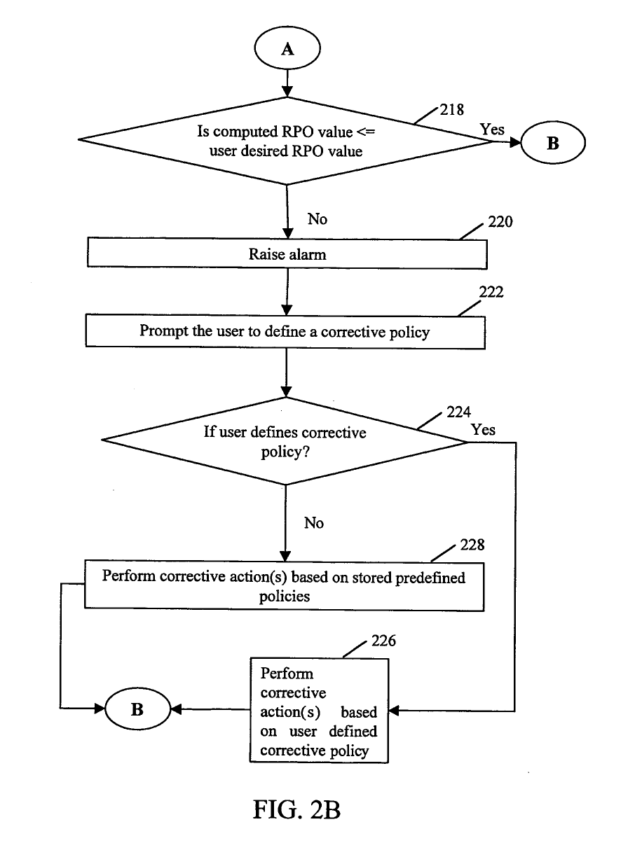

FIG. 2 is a flowchart illustrating the steps involved in monitoring, measurement and management of Recovery Time Objective (RTO) of an enterprise IT business continuity or disaster recovery solution, in accordance with an embodiment of the present invention.

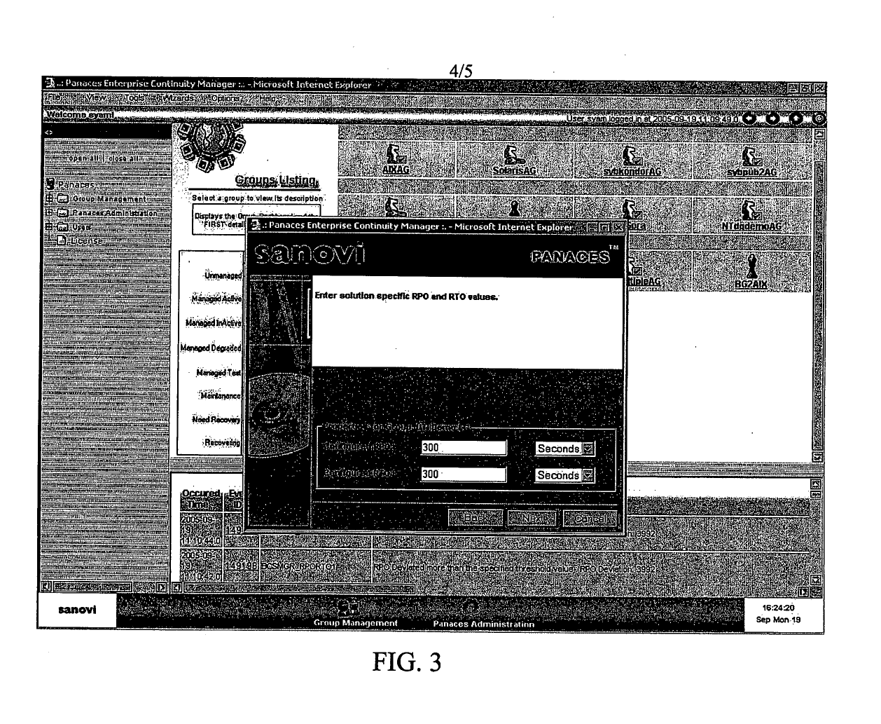

At step 202, a user is prompted to enter a desired RTO value. In an embodiment of the present invention, the user is prompted to enter a desired RTO value for either the entire solution or an application thereof, via a graphical user interface (GUI). FIG. 3 illustrates an exemplary GUI for prompting the user to input a desired RTO value. In an embodiment of the present invention, the user may also be prompted to input a desired recovery point objective (RPO) value. RPO for an IT enterprise business continuity or disaster recovery solution is a time measure that defines the amount of data loss that is acceptable to the IT enterprise when a production or application site becomes unavailable due to an outage. In another embodiment, the user may only be prompted to input a desired RTO value.

In other embodiments of the present invention, the user may enter desired RTO value using a command line interface.

In an exemplary embodiment of the present invention, an Oracle database running on the first computer 104 must be available continuously. Consequently, an instance of Oracle database is also maintained, in standby condition, on the second computer 106, which computer is maintained in a hot standby mode. Oracle database is protected and recovered using the archive log technique, which is well known in the art. Archive logs are periodically dumped on the first computer 104. These logs are also periodically replicated to the second computer 106 via a WAN connection. The archive logs are then applied to the Oracle instance running on the second computer 106.

The desired value of RTO as input by the user is used to determine configuration and behavior of rest of the components that make up the solution. In the embodiment of the present invention, where the application that must be available continuously is an Oracle database, the RTO value influences the following:
initial archive log size configuration of the Oracle instance on the first computer 104
archive log apply periodicity to the Oracle instance running on the second computer 106 is calculated based on the input RTO value
number of pending archive logs that must be applied on the second computer 106 per time unit depends on the input RTO value
readiness of services and the Oracle instance on the second computer 106 is determined using input RTO value

At step 204, time and periodic settings are computed and configured for the solution based on the value of RTO input at step 202. An enterprise IT business continuity or disaster recovery solution typically comprises an application that is required to be available continuously along with its environment, a data protection/replication scheme and the entire infrastructure supporting the solution comprising server, storage & networks. Examples of the time and periodic settings that are computed comprise:
computing a periodic interval for performing an operation to ensure data consistency of replicated data on the second computer 106
computing a periodic interval for performing an operation to apply replicated data to the application 116 running on the second computer 106
computing readiness level of the second computer 106, including the server and the operating system readiness level that are required to meet the input RTO value
computing state of secondary network services that must be running to meet input RTO value, which comprises computing states of all hardware and software components of system 100
computing state of any associated storage units that are required to meet the input RTO value. In an embodiment of the present invention, states of the first storage unit 110 and the second storage unit 112 that are required to meet the input RTO value are computed.

Once the time and periodic settings are computed based on the user input RTO value, the computed settings are configured for the components of the solution, at step 206. In an embodiment of the present invention, the computed settings are configured by the management server 102 by communicating with its agents deployed on the various components of the system 100, to configure the computed values for each of the components.

At step 208, a current state of an application of the solution, which is required to be available continuously along with any storage associated with the application is obtained. In an embodiment of the present invention, a current state of the application 114 or/and the application 118 is obtained by the management server 102 by polling the agents 122 and 126 which are integrated with the applications 114 and 118 respectively. Also, a current state of the first storage unit 110 and the second storage unit 112 is obtained by the management server 102 by polling the agents 134 and 136, which are integrated with the first storage unit 110 and the second storage unit 112 respectively. Examples of the values polled comprise:
state of application, where obtained values may be ‘open’ or ‘closed’ or ‘active’ or ‘degraded’; and
application load
application response time

At step 210, a current state of a data protection scheme that is coupled with the application of the solution, which is required to be available continuously, is obtained. In an embodiment of the present invention, a current state of the data replication scheme 116 or/and the data replication scheme 120 is obtained by the management server 102 by polling the agents 124 and 128 which are integrated with the data protection schemes 116 and 120 respectively. Examples of the values polled comprise:
last data signature copied from the first computer 104
last data signature written to the second computer 106 time estimate of application recovery operation

At step 212, a current state of a network supporting the application of the solution, which is required to be available continuously, is obtained. In an embodiment of the present invention, a current state of the network 108 is obtained by the management server 102 by polling the agents 130 and 132 which are integrated with the network 108. Examples of the values polled comprise:
network link utilization
alternate network readiness
network alternate route information
time to switch to alternate networks
At step 214, current states of operating systems that support the solution, are obtained. In an embodiment of the present invention, a current state of the operating system 138 or/and the operating system 142 is obtained by the management server 102 by polling the agents 140 and 144 which are integrated with the operating systems 138 and 142 respectively. Examples of the values polled comprise:
CPU load on the first computer 104 and the second computer 106
number of file systems mounted on the operating systems 140 or/and 144
current run level of the operating systems 140 or/and 144
current level of network and daemon services running on the first computer 104 and the second computer 106

At step 216, a real time RTO value is calculated using the values of the state of the application and associated storage, the state of the data protection scheme, the state of the network and the state of the operating system, obtained at steps 208, 210, 212 and 214. In an embodiment of the present invention, the current value of RTO is computed by the management server 102 by using values obtained by periodically polling each of its agents. The computed value of RTO yields the amount of time required to bring up all components of the system 100 to a required state from their current states to enable the second computer 106 to offer all the required services such as are provided by the first computer 104. Examples of values used to calculate the current value of RTO comprise:
time required to apply replicated data to the application 118 running on the second computer 106
time required for the second computer 106 server to boot to required service level
time required to mount and access the second storage unit 112 associated with the second computer 106
time required to switch network configuration such that the user may access application 118 running on the second computer 106

In an embodiment of the present invention, in order to compute a current or real time RTO value, an estimated time period for completion of every action that needs to be performed to enable the second computer 106 to boot to a required service level, is calculated in real time. Then, the real time RTO value is computed by summing all the estimated time periods.

In other embodiments other methods and formulae may be used to compute a current RTO value for the solution, based on the values polled by the management server 102.

In the exemplary embodiment of the present invention, where an Oracle database running on the first computer 104 must be available continuously current RTO value is determined by obtaining the following information:
current state of the operating system on the second computer 106 to obtain information such as whether the operating system is operating in a single user or a multi user mode
current state of the Oracle instance running on the second computer 106 to obtain information such as whether the second computer 106 is operating in a in a read only mode or standby mode
current number of pending archive logs on the second computer 106
an estimation of time period required to apply each archive log to the Oracle instance running on second computer 106
an estimation of time period required to bring up the Oracle instance running on the second computer 106
an estimation of time period required to effect network related settings
an estimation of a time period required to effect any other settings that enable access to the Oracle instance running on the second computer 106
   Then, current real time RTO value is calculated using the above obtained information and by summing the obtained time periods.

At step 218, the computed RTO value is compared to the RTO value that was input by the user at step 202. If the computed value is less than or equal to the user input RTO value, steps 208 to 218 are repeated. If the computed value is greater than the user input RTO value an alarm is raised, at step 220.

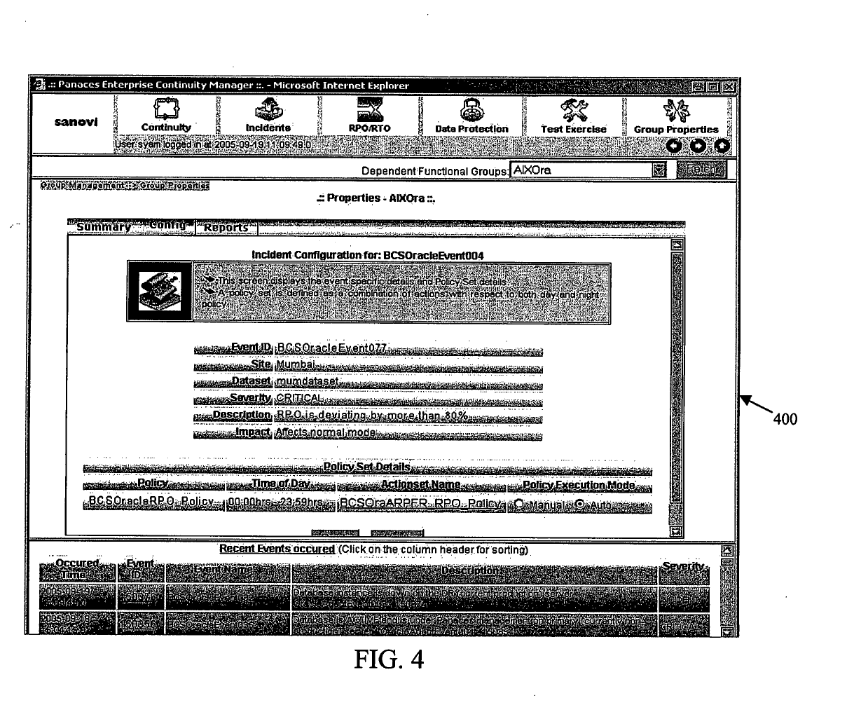

In an embodiment of the present invention, the difference between the computed RTO value and the user input RTO value is presented to the user via a GUI. FIG. 4 illustrates an exemplary screenshot of a GUI conveying the difference between the computed and user input RTO values, in accordance with an embodiment of the present invention. The GUI 400 presents the user with additional information such as the identity of the application, which is required to be available continuously, and the severity and impact of the difference between the computed and user input RTO values. In other embodiments of the present invention, some other additional information may also be presented to the user along with the difference between the computed and user input RTO values.

At step 222, the user is prompted to define a corrective policy, in order to restore the real time computed RTO value to the RTO value initially input by the user. In an embodiment of the present invention the user may be prompted to define a corrective policy via a GUI. This GUI may be the same or be different from the GUI which presents the difference between the computed and user input RTO values. The GUI may also present the user with a set of corrective policy options and prompt the user to either choose one of those or define a new corrective policy.

If the user chooses to define a corrective policy at step 224, then at step 226 a corrective action that restores the RTO value is taken based on the user defined corrective policy. Upon completion of step 226, steps 208 to 218 are repeated.

If the user chooses not to define a corrective policy at step 224, then at step 228 a corrective action that restores the RTO value is taken based on a predefined corrective policy. In an embodiment of the present invention, a set of predefined corrective policies are stored in the management server 102 and these policies are applied by the management server 102 onto the first computer 104, the second computer 106 or the network 108, based on the states of these components as obtained via the agents deployed on them. A predefined corrective policy is selected for execution based on the cause of deviation of the computed real time RTO value from the user input RTO value. RTO deviation may occur due to various causes. Examples of such causes comprise:
second computer 106 not being available
volume of replicated data on the second computer 106 that must be applied to the application 118 being too large
secondary network or storage services not being available
   Examples of corrective policies that can be executed in response to the above causes are:
upgrade second computer 106 server to a required level of operating system services
limit volume of data recovery if volume of replicated data is too large on the second computer 106
   In various embodiments of the present invention, each of the above corrective policies may be executed automatically on detection of a difference between the computed and user input RTO values, or require manual consent before execution. Upon completion of step 228, steps 208 to 218 are repeated.

In the exemplary embodiment of the present invention, where an Oracle database running on the first computer 104 must be available continuously, the following corrective actions may be taken when the computed real time RTO value deviates from the user input RTO value:
If the inequality:
   (number of pending archive logs to be applied*time required to apply each archive log)>=input or configured RTO
holds true on the second computer 106 an alarm is raised, and a corresponding predefined action to the alarm action is taken
If the inequality:
   (transition time required to change from the current state/mode of the database to the running state)>=configured RTO
holds true on the second computer 106, an alarm is raised, and a corresponding predefined action to the alarm action is taken
If the inequality:
   (transition time form the current state of the Operating system, the network, the storage to the running state)>=configured RTO
olds true on the second computer 106, an alarm is raised, and a corresponding predefined action to the alarm action is taken

In various embodiments of the present invention, the system and method herein can operate in varied environments and on heterogeneous platforms such as heterogeneous servers and operating system environments. Examples of servers and central processing unit types that are supported by the present invention comprise Intel Pentium class, SUN Sparc, IBM PowerPC etc. Examples of the various operating systems that are supported are Microsoft Windows 2000, Microsoft Windows 2003, SUN Solaris 8, SUN Solaris 9, IBM AIX 5.3 etc.

While the present invention has been shown and described with reference to exemplary embodiments, it will be understood by those skilled in the art that various changes in form and detail may be made therein without departing from or offending the spirit and scope of the invention as defined by the appended claims.

What is claimed is:

1. A system for management of Recovery Time Objective (RTO) of a business continuity or disaster recovery solution, the system comprising:
a management server logically coupled with at least a first computer, at least a second computer, and a network coupling the first and the second computers;
at least one of the first and second computers hosting at least one continuously available application, at least one data protection scheme for replicating the application data and at least one operating system; the application data being periodically replicated from the first computer to at least the second computer; the system managing RTO by inputting an RTO value for the solution, calculating a real time RTO value for the solution, and making the real time RTO value less than or equal to the input RTO value.

2. The system of claim 1, wherein the first and the second computers are coupled to one or more storage units.

3. The system of claim 1, wherein a plurality of agents of the management server are deployed on at least the first computer, at least the second computer, the network coupling the first and the second computers, and the one or more storage units.

4. The system of claim 3, wherein the management server periodically polls at least one of its agents integrated with at least, the application, the data protection scheme and the operating system running on the first computer, the application, the data protection scheme and the operating system running on the second computer, and the network, for calculating the real time RTO value.

5. The system of claim 3, wherein the management server periodically polls at least one of its agents integrated with at least one storage unit, for calculating the real time RTO value.

6. The system of claim 1, wherein the data protection scheme comprises data replication techniques based on one or more of tape backup, disk backup, block level replication, file level replication, point in time replication and archive logs.

7. The system of claim 1 being configurable on heterogeneous platforms comprising heterogeneous servers and operating systems.

8. A method for management of Recovery Time Objective (RTO) of a business continuity or disaster recovery solution, the method comprising the steps of:
a inputting an RTO value for the solution;
b. calculating a real time RTO value for the solution; and
c. managing the real time RTO value to make it less than or equal to the input RTO value.

9. The method of claim 8, further comprising the step of continuously repeating the steps of calculating a real time RTO value for the solution and managing the real time RTO value to make it less than or equal to the input RTO value.

10. The method of claim 8, wherein the step of inputting an RTO value for the solution comprises the steps of:
a. prompting a user to input a desired RTO value for the solution;
b. computing time and periodic setting values for the solution, based on the desired RTO value; and
c. configuring the solution, based on the computed time and periodic setting values.

11. The method of claim 8, wherein the step of calculating a real time RTO value for the solution comprises the steps of:
a. obtaining current state of an application of the solution;
b. obtaining current state of a data protection scheme replicating the application data;
c. obtaining current state of a network supporting the solution;
d. obtaining current state of an operating system supporting the solution; and
e. calculating a real time RTO value using at least one of the current obtained values of each of the state of the application, the data protection scheme, the network and the operating system.

12. The method of claim 11, wherein the data protection scheme comprises data replication techniques based on one or more of tape backup, disk backup, block level replication file level replication, point in time replication and archive logs.

13. The method of claim 8, wherein the step of managing the real time RTO value to make it less than or equal to the input RTO value comprises the steps of:
a. raising an alarm if the computed RTO value greater than the input RTO value; and
b. performing at least one corrective action based on at least one predefined corrective policy.

14. The method of claim 8, wherein the step of managing the real time RTO value to make it less than or equal to the input RTO value comprises the steps of:
a. raising an alarm if the computed RTO value is greater than the input RTO value;
b. prompting the user to define at least one corrective policy; and
c. performing at least one corrective action based on the user defined corrective policy.

15. The method of claim 8, wherein the step of managing the real time RTO value to make it less than or equal to the input RTO value comprises the step of repeating the steps of calculating a real time RTO value for the solution if the computed RTO value is less than or equal to the input RTO value.

16. The method of claim 10 wherein, the step of computing time and periodic setting values for the solution based on the desired RTO value, comprises one or more of the steps of:
a. computing a periodic interval for performing an operation to ensure data consistency of replicated data on the second computer;
b. computing a periodic interval for performing an operation to apply replicated data to the application running on the second computer;
c. computing readiness level of the second computer;
d. computing readiness level of the one or more storage unit; and
e. computing readiness level of the network.

17. The method of claim 8 being operable on heterogeneous platforms comprising heterogeneous servers and operating systems.

18. A method for management of Recovery Time Objective (RTO) of a business continuity or disaster recovery solution, the method comprising the steps of:
a. prompting a user to input a desired RTO value for the solution;
b. computing time and periodic setting values for the solution based on the input RTO value;
c. configuring the solution based on the computed time and periodic setting values;
d. obtaining current state of an application of the solution;
e. obtaining current state of a data protection scheme replicating the application data;
f. obtaining current state of a network supporting the solution;
g. obtaining current state of an operating system supporting the solution
h. calculating a real time RTO value using at least one of the current obtained values of each of the state of the application, the data protection scheme, the network and the operating system;
i. repeating steps d to h if the computed RTO value is less than or equal to the input RTO value;
j. raising an alarm if the computed RTO value is greater than the input RTO value;
k. prompting the user to define at least one corrective policy;
l. performing corrective actions based on the user defined corrective policy if the user defines at least one corrective policy; else
m. performing corrective actions based on at least one predefined corrective policy; and
n. repeating steps d to h.

19. A computer program product comprising a computer usable medium having a computer readable program code embodied therein for management of Recovery Time Objective (RTO) of a business continuity or disaster recovery solution, the computer program product comprising:
a. program instruction means for inputting an RTO value for the solution;
b. program instruction means for calculating a real time RTO value for the solution; and
c. program instruction means for managing the real time RTO value to make it less than or equal to the input RTO value.

20. The computer program product of claim 19, further comprising program instruction means for continuously repeating the steps of calculating a real time RTO value for the solution and managing the real time RTO value to make it less than or equal to the input RTO value.

21. The computer program product of claim 19, wherein program instruction means for inputting an RTO value for the solution comprise:
a. program instruction means for prompting a user to input a desired RTO value for the solution;
b. program instruction means for computing time and periodic setting values for the solution, based on the desired RTO value; and
c. program instruction means for configuring the solution, based on the computed time and periodic setting values.

22. The computer program product of claim 19, wherein program instruction means for calculating a real time RTO value for the solution comprise:
a. program instruction means for obtaining current state of an application of the solution;
b. program instruction means for obtaining current state of a data protection scheme replicating the application data;
c. program instruction means for obtaining current state of a network supporting the solution;
d. program instruction means for obtaining current state of an operating system supporting the solution; and
e. program instruction means for calculating a real time RTO value using at least one of the current obtained values of each of the state of the application, the data protection scheme, the network and the operating system.

23. The computer program product of claim 22, wherein the data protection scheme comprises data replication techniques based on one or more of tape backup, disk backup, block level replication file level replication, point in time replication and archive logs.

24. The computer program product of claim 19, wherein program instruction means for managing the real time RTO value to make it less than or equal to the input RTO value comprise:
a. program instruction means for raising an alarm if the computed RTO value is greater than the input RTO value; and
b. program instruction means for performing at least one corrective action based on at least one predefined corrective policy;

25. The computer program product of claim 19, wherein the program instruction means for managing the real time RTO value to make it less than or equal to the input RTO value comprise:
a. program instruction means for raising an alarm if the computed RTO value is greater than the input RTO value;
b. program instruction means for prompting the user to define at least one corrective policy; and
c. program instruction means for performing at least one corrective action based on the user defined corrective policy;

26. The computer program product of claim 19, wherein the program instruction means for managing the real time RTO value to make it less than or equal to the input RTO value comprise program instruction means for repeating the steps of calculating a real time RTO value for the solution, if the computed RTO value is less than or equal to the input RTO value.

27. The computer program product of claim 21 wherein, the program instruction means for computing time and periodic setting values for the solution based on the desired RTO value, comprise one or more of:
a. program instruction means for computing a periodic interval for performing an operation to ensure data consistency of replicated data on the second computer;
b. program instruction means for computing a periodic interval for performing an operation to apply replicated data to the application running on the second computer;
c. program instruction means for computing readiness level of the second computer; and
d. program instruction means for computing readiness level of the one or more storage unit; and
e. computing readiness level of the network.

28. The computer program product of claim 19 being operable on heterogeneous platforms comprising heterogeneous servers and operating systems.
